(19) United States
(12) Patent Application Publication
(10) Pub. No.: US 2011/0302913 A1
(43) Pub. Date: Dec. 15, 2011

(54) Hydrostatic System Having A Hydropneumatic Accumulator

(75) Inventors: Matthias Mueller, Langenau (DE); Peter Schmuttermair, Gessertshausen (DE)

(73) Assignee: Robert Bosch GmbH, Stuttgart (DE)

(21) Appl. No.: 13/133,724

(22) PCT Filed: Dec. 10, 2009
(86) PCT No.: PCT/EP2009/008834

§ 371 Date: Aug. 29, 2011

(30) Foreign Application Priority Data
Dec. 10, 2008 (DE) 10 2008 061 350.9

(51) Int. Cl. F15B 1/02

(52) U.S. Cl. 60/413

(57) ABSTRACT

A hydrostatic system includes a hydropneumatic accumulator which is connected via a hydraulic resistance to a compensating volume. Means are provided in the hydrostatic system for measuring a pressure prevailing on that side of the hydraulic resistance which faces towards the compensating volume. A volume flow restricting device may be actuated if the pressure prevailing there exceeds a limit value.

The invention relates to a hydrostatic system having a hydropneumatic accumulator which is connected to a compensating volume via hydraulic resistance.

Hydrostatic systems often use a high-pressure accumulator in order to intermediately store energy released from the system and therefore to enable it to be recovered with the subsequent performance of work. Thus, it is known from DE 10 2005 060 990 A1 to be able to couple a hydrostatic piston machine to a travel drive. This hydrostatic piston machine conveys pressure medium into a high-pressure accumulator when the vehicle is being braked. The high-pressure accumulator is usually designed as a hydropneumatic accumulator in which a gas-filled bubble generates a counter pressure against the pressure medium conveyed. Either a low-pressure accumulator or else a tank volume is used as compensating volume. For the recovery of energy, pressure medium is expanded out of the high-pressure accumulator via the hydrostatic piston machine and delivered to the compensating volume. The compensating volume is usually provided with a venting device.

The gas bubble present in the high-pressure accumulator may, under unfavorable circumstances, become leaky, and in some cases may even burst. Consequently, a pressure medium penetrated by the compressible medium of the bubble is fed into the low-pressure region of the hydrostatic system via the hydrostatic piston machine. Expansion results in a pressure rise on the low-pressure side, since the installed venting device cannot discharge sufficiently quickly the high gas volume flow which occurs. In order to avoid damage caused by this to components, in particular also the bursting of components, the venting device would therefore have to be designed for high gas throughput and the other components would have to have a design with considerable pressure stability. However, this dimensioning leads to an undesirable increase in the overall weight of the hydrostatic system.

Moreover, the detection of a pressure loss from a high-pressure accumulator is known from U.S. Pat. No. 6,971,411 B1.

The object of the invention, therefore, is to provide a hydrostatic system in which a pressure rise occurring as a result of the intermixing of pressure medium and compressible medium from the hydropneumatic accumulator is avoided or at least limited on the low-pressure side.

The object is achieved by means of the hydrostatic system according to the invention having the feature of claim 1.

The hydrostatic system according to the present invention has a hydropneumatic accumulator which is connected to a compensating volume via hydraulic resistance. The hydraulic resistance may in this case be, for example, a piston machine, if the system described is one already referred to with regard to the prior art. It is just as possible, however, that the hydraulic resistance is implemented by a valve operating with a throttling cross section or by a similar hydraulic throttle device.

According to the invention, then, a means for detecting a pressure prevailing on the low-pressure side, that is to say on that side of the hydraulic resistance which faces the compensating volume, is provided in the hydrostatic system. Furthermore, a volume flow limitation device is provided, which, when a limit value is overshot, can be actuated by the pressure prevailing on that side of the hydraulic resistance which faces the compensating volume. It is thus detected whether an undesirable pressure rise occurs on the low-pressure side of the hydraulic resistance. If this is so, because the pressure rise is generated by the compressible medium located in the pressure medium, the pressure medium quantity fed per unit time from the high-pressure side to the low-pressure side is reduced. For this purpose, the volume flow limitation device can be actuated as a function of the determined pressure. Consequently, that quantity of compressible medium which arrives on the low-pressure side is reduced overall by means of a reduction in the overall volume flow. Consequently, the pressure rise can be set at a low value, and the expanded compressible medium can also be discharged easily via a venting device having relatively low dimensioning.

Advantageous developments of the hydrostatic system according to the invention are given in the subclaims.

In particular, there is provision for the volume flow limitation device to be an adjustment device which acts upon a hydrostatic machine forming the hydraulic resistance. The hydrostatic machine is designed adjustably, so that the volume flow limitation device, when actuated, causes a reduction in the volume flow flowing through the hydrostatic by reducing the absorption volume. It is thereby possible, in particular, to avoid a complete shutdown of the system. However, operating with diminished effect, that is to say with a reduced volume flow, continues to be possible.

Alternatively, the hydraulic resistance may also have a settable throttle cross section, as is the case, for example, in valve devices with a throttling cross section. When the volume flow limitation device which has a suitable throttle cross section is actuated, this throttle cross section is reduced, so that the pressure medium stream flowing from the high-pressure side to the low-pressure side is likewise reduced. In particular, such a device may also be combined with a hydraulic piston machine. The use of such a settable throttle cross section is appropriate, for example, when the hydrostatic piston machine used is one with a constant displaced or absorption volume.

According to a further preferred embodiment, a pressure sensor is arranged as a means for detecting the pressure on the low-pressure side, that is to say on the side facing the compensating volume with respect to the hydraulic resistance. In general, a pressure sensor is in the first place a detection device which emits an electrical signal as a function of the detected pressure. This signal may either be proportional to the detected pressure or else, in an especially preferred development, merely emit, for example, a constant voltage which is generated when a permanently set limit value is overshot. In this case, the pressure sensor is designed in simplified form as a pressure switch. If a pressure sensor, also the pressure sensor designed as a pressure switch, is used, the electrical signal generated is preferably fed to a control device which is connected to the volume flow limitation device and activates the latter. By means of such a control device, the further processing of a pressure value by the control software used can be influenced in a simple way. In particular, it is then possible by parametrization subsequently to influence the set limit values. Thus, for example, when individual components are exchanged, the resulting need for increasing the pressure at least prevailing on the low-pressure side can be attended to; for example, should a pressureless tank volume as compensating volume need to be exchanged for a low-pressure accumulator.

According to an alternative embodiment, there is provision for using the pressure prevailing on the low-pressure side in order to actuate the volume flow limitation device. For this purpose, a connecting line for the connection of a line connecting the hydraulic resistance to the compensating volume is provided, which line is connected to the volume flow limitation device. Such a connecting line makes it possible to activate the volume flow limitation device directly by means of the rising pressure on the low-pressure side.

According to a preferred development, this pressure rise on the low-pressure side may be used in order to actuate a pilot control valve. The pilot control valve is an integral part of the volume flow limitation device and is itself connected to the connecting line.

Preferred exemplary embodiments are illustrated in the drawing in which:

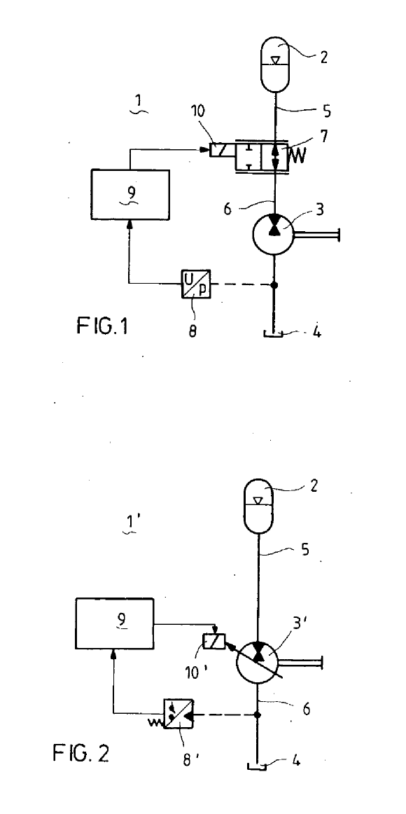

FIG. 1 shows a first exemplary embodiment with a valve having a throttling cross section arranged between a hydraulic resistance and a hydropneumatic accumulator;

FIG. 2 shows a second exemplary embodiment with an adjustable hydrostatic machine as hydraulic resistance;

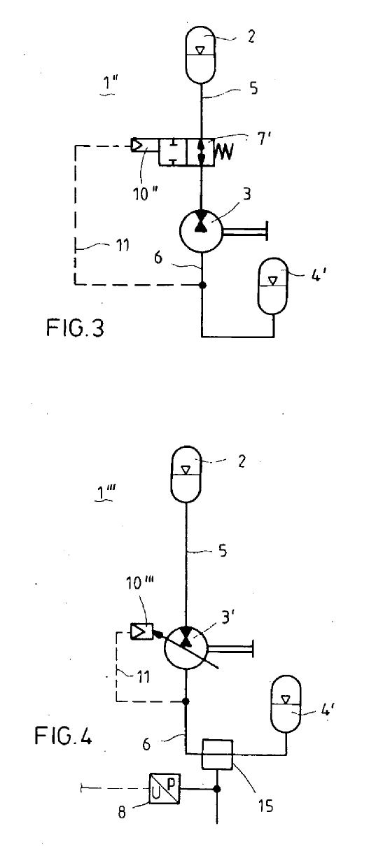

FIG. 3 shows hydraulic activation of a switching valve as a volume flow limitation device by means of the pressure prevailing on the low-pressure side; and

FIG. 4 shows a fourth exemplary embodiment with a pressure at the low-pressure side acting upon an adjustment device as a volume flow limitation device of the hydrostatic machine.

A first exemplary embodiment of the hydrostatic system according to the invention is shown in FIG. 1. The hydrostatic system 1 comprises a hydropneumatic accumulator 2. The hydropneumatic accumulator is designed as a high-pressure accumulator and has a volume delimited elastically with respect to a liquid. This volume is designated as a gas bubble and is filled with a compressible medium, mostly nitrogen. Furthermore, the hydrostatic system 1 has hydraulic resistance. In the exemplary embodiment illustrated, the hydraulic resistance is a hydrostatic piston machine 3 which may be operated as a pump and as a motor. When used in a regenerative travel drive, the hydrostatic machine 3 is employed, during hydrostatic braking, to suck in pressure medium from a tank volume forming a compensating volume and to convey said pressure medium counter to the pressure prevailing in the hydropneumatic accumulator 2. For this purpose, the hydropneumatic accumulator 2 is connected to the hydrostatic machine 3 via a high-pressure line 5. A low-pressure line 6 is provided for connection between the hydrostatic machine 3 and the tank volume 4.

A valve 7 having a settable throttling cross section is provided in the high-pressure line 5. The valve 7 is designed as a 2/2-way valve and, in the position of rest, is held by a spring in its non-throttled position. The valve 7 remains in this position as long as the system is operating faultlessly. To detect a gas loss, for example if the bubble bursts, from the hydraulic accumulator 2, a pressure sensor 8 is provided as means for detecting the pressure on the low-pressure side and, in the exemplary embodiment illustrated, emits an electrical signal proportional to the detected pressure. The pressure sensor 8 measures the pressure prevailing in the low-pressure line 6, a measuring point in the immediate vicinity of the connection of the hydrostatic machine 3 preferably being provided as the measurement location.

If a pressure rise occurs on the low-pressure side and therefore in the low-pressure line 6 as a result of the bubble bursting in the hydropneumatic accumulator 2, an increasing electrical signal is transmitted from the pressure sensor 8 to a control apparatus 9. The control apparatus 9 is provided for activating the electrically actuable valve 7. When a limit value for the pressure prevailing in the low-pressure line 6 is overshot, the control apparatus 9 emits a control signal to the electromagnet 10 controlling the valve 7. Consequently, the valve 7 is brought out of its position of rest predetermined by the spring into a throttling position. In the second end position, the valve 7 is closed completely, and extraction of pressure medium from the hydropneumatic accumulator via the hydrostatic machine is impossible. However, as a function of the magnitude of the electrical signal which the pressure sensor transmits to the electrical control apparatus 9, the valve 7 can preferably also be set to intermediate positions, as illustrated by the adjustable valve 7 in FIG. 1. The valve thus acts as a volume flow limitation device.

In contrast to this, a modified hydrostatic system 1′ is illustrated in FIG. 2. The elements which are identical to the elements in FIG. 1 are given the same reference symbols. A full new description is dispensed with in order to avoid repetition. However, in contrast to FIG. 1, there is now no valve 7 arranged as a volume flow limitation device in the high-pressure line 5. Instead, the reduction in the volume flow from the high-pressure side to the low-pressure side takes place by means of an adjustment of the in this case adjustably designed hydrostatic machine 3′. For this purpose, an adjustment device 10′ is provided. The adjustment device 10′ is actuable, for example, via an electromagnetically actuated valve and is illustrated merely diagrammatically. The adjustment device 10 in this case forms the volume flow limitation device, since it acts upon the volume flow generated via the hydrostatic machine 3′.

Instead of the pressure sensor 8 of FIG. 1, which transfers a signal proportional to the detected pressure to the control apparatus 9, in this case a simple pressure switch 8′ is used. This pressure switch 8′ can be set at a fixed pressure value, above which it feeds an electrical signal to the control apparatus 9. When the control apparatus 9 receives a corresponding electrical signal from the pressure switch 8′, the adjustment device 10 is actuated as a volume flow limitation device and adjusts the hydrostatic machine 3′ toward a decreasing displaced volume. In the simple version, as shown in FIG. 2, if there is a signal from the pressure switch 8 the hydrostatic machine 3′ is set as a precaution to a zero absorption volume.

FIG. 3 shows a further variant in which, instead of the electric detection of the pressure rise on the low-pressure side in the event of a bubble burst, a purely hydraulic solution is provided. In this case, in contrast to FIG. 1, the hydraulically actuated valve 7′ is designed as a straightforward switching valve. It is held once again in its open position by the spring. In the opposite direction, a measurement surface 10′ is provided, which, to detect the pressure, is acted upon via a connecting line 11 by the pressure of the low-pressure line. If, then, the pressure of the low-pressure line 6 overshoots a limit value predetermined by the spring, the valve 7′ is brought into its closed position. Furthermore, instead of the compensating volume in the form of the tank volume 4, in this case a low-pressure accumulator 4′ is provided which, as illustrated, may likewise be designed as a hydropneumatic accumulator.

FIG. 4 shows, furthermore, a fourth exemplary embodiment of the system 1″′, in which hydraulic activation of the adjustable hydrostatic machine 3′ is provided. Instead of electromagnetic actuation of the adjustment device as a volume flow limitation device, in this case hydraulic actuation 10″′ of the adjustment device 10′″ of the hydrostatic machine 3′ is provided. In both instances, that is to say both in the exemplary embodiment of FIG. 3 and in the exemplary embodiment of FIG. 4, direct hydraulic activation of the volume flow limitation device is shown. It is also conceivable, however, that the volume flow limitation devices comprise a pilot control valve, so that, particularly when an adjustment device 10″′ of the hydrostatic machine 3′ is used, a higher actuating pressure is available.

There is provision for using a low-pressure accumulator 4′ in each case in FIGS. 3 and 4. Thus, on account of the prestress generated by the low-pressure accumulator 4′, there may be problems in detecting a pressure rise. A device 15 connected to the low-pressure line 6 is then provided. This device 15 illustrates diagrammatically coupling of the low-pressure line 6 to a tank volume which is under atmospheric pressure. Such a device 15 may be, for example, a scavenging valve if the hydrostatic machine 3′ is a hydraulic motor operated in a closed hydraulic circuit. Via such a scavenging valve, pressure medium is extracted from the line in each case carrying the low pressure and is discharged into the tank volume which is under atmospheric pressure. By means of the pressure sensor 8, this pressure is detected and a corresponding control signal is generated, as already explained with reference to FIG. 1. The design of the device 15 as a scavenging valve is to be understood as being merely by way of example. If the hydrostatic machine is a pump, however, the pressure may be detected in a leakage duct. Depending on the set-up of the system, it is advantageous to use an already existing connection to the tank volume which is under atmospheric pressure.

It goes without saying that the individual features of the exemplary embodiments shown in FIG. 1-4 may also be combined with one another. For example, the low-pressure accumulator 4′ of FIGS. 3 and 4 may also be used as a compensation volume instead of the tank volume 4 in FIGS. 1 and 2. Moreover, the pressure sensor 8 may also be used in the exemplary embodiment of FIG. 2 and the pressure switch 8′ of FIG. 2 may also be used in the exemplary embodiment of FIG. 1. It is likewise possible to design the exemplary embodiment of FIG. 3 with a continuously settable valve 7 of FIG. 1 or, conversely, to provide only a switching valve 7′ in FIG. 1.

Moreover, it is also possible, in the version of FIG. 1, to use directly as a switching valve an electrical signal, generated via a pressure switch 8′, for activating the electromagnet of the switching valve. There is then no need to interpose a control apparatus for the purpose of evaluating the signal from the pressure sensor.

1. A hydrostatic system comprising:
a hydropneumatic accumulator connected to a compensating volume via a hydraulic resistance;
a means for detecting a pressure prevailing on that a side of the hydraulic resistance which faces the compensating volume; and
a volume flow limitation device being actuable when a limit value for the pressure is overshot.

2. The hydrostatic system as claimed in claim 1, wherein the volume flow limitation device is an adjustment device which acts upon an adjustable hydrostatic machine acting upon the hydraulic resistance.

3. The hydrostatic system as claimed in claim 1, wherein the hydraulic resistance has a settable throttle cross section which can be reduced when the limit value is overshot.

4. The hydrostatic system as claimed in claim 1, wherein a pressure sensor is the means for detecting the pressure.

5. The hydrostatic system as claimed in claim 4, wherein the pressure sensor is a pressure switch.

6. The hydrostatic system as claimed in claim 4, wherein the pressure sensor is connected to a control device configured to activate the volume flow limitation device.

7. The hydrostatic system as claimed in claim 1, wherein for actuating the volume flow limitation device, a connecting line for the connection of a line connecting the hydraulic resistance to the compensating volume to the volume flow limitation device is provided.

8. The hydrostatic system as claimed in claim 7, wherein the volume flow limitation device includes a pilot control valve which is connected to the connecting line (11).
